(19) United States
(12) Patent Application Publication
(10) Pub. No.: US 2026/0243893 A1
(43) Pub. Date: Aug. 20, 2026

(54) ULTRASOUND SYSTEMS CONFIGURED TO GENERATE DIFFERENT WAVEFORMS

(71) Applicant: BRAD PERIPHERAL VASCULAR, INC., Franklin Lakes, NJ (US)

(72) Inventors: Hely Li, Shanghai (CN); Feipeng Guo, Shanghai (CN); Peng Guo, Shanghai (CN)

(21) Appl. No.: 19/053,845

(22) Filed: Feb. 14, 2025

(51) Int. Cl. G01S 15/89; G01S 7/52; G01S 7/524

(52) U.S. Cl. CPC G01S 15/899; G01S 7/5202; G01S 7/52096; G01S 7/524

(57) ABSTRACT

An example ultrasound system includes a controller. The ultrasound system also includes a digital-to-analog converter (“DAC”) that is in communication with the controller. The DAC is configured to generate a first low voltage waveform pulse (“WP”) responsive to receiving instructions from the controller. The ultrasound system also includes at least one power amplifier in communication with the DAC. The DAC is configured to send the first low voltage WP to the power amplifier and the power amplifier is configured to generate a first high voltage WP responsive to receiving the first low voltage WP. The power amplifier is configured to transmit the first high voltage WP to an ultrasound transducer. The ultrasound transducer may generate a first ultrasound wave responsive to receiving the first high voltage WP.

### BACKGROUND

Intravascular ultrasound (“IVUS”) is an intravascular imaging modality that can be used in various interventional disciplines to characterize lesion morphology, quantify plaque load, guide device sizing, evaluate device placement, and identify complications. IVUS is the most commonly used imagining technique for plaque diagnosis, providing cross-sectional images of vascular structures with a resolution of approximately 100 μm and a depth of about 7 mm.

IVUS can play an important role in decision making during percutaneous coronary intervention procedures, including pre-procedure evaluation and post-procedure optimization. IVUS is used to assess plaque nature and characteristics, develop appropriate pretreatment strategies, measure lesion length and reference segment vessel diameter, and select appropriate stent diameter, length, and footing points. Prior to post-percutaneous coronary intervention procedures, IVUS is used to identify stent expansion and apposition, and complications such as stent edge entrapment to target and optimize the immediate post-percutaneous coronary intervention procedure outcomes.

### SUMMARY

Embodiments disclosed herein related to ultrasound systems configured to generate different ultrasound waves and methods of using the same. In an embodiment, an ultrasound system is disclosed. The ultrasound system includes a controller and a digital-to-analog converter in communication with the controller. The digital-to-analog converter is configured to generate a first low voltage waveform pulse responsive to receiving one or more instructions from the controller. The ultrasound system also includes at least one power amplifier in electrical communication with the digital-to-analog converter. The at least one power amplifier is configured to generate a first high voltage waveform pulse after receiving the first low voltage waveform pulse. The first high voltage waveform pulse exhibits an amplitude that is greater than the first low voltage waveform pulse. The at least one power amplifier is configured to transmit the first high voltage waveform pulse to an ultrasound transducer.

In an embodiment, a method of using an ultrasound system is disclosed. The method includes, with a controller, instructing a digital-to-analog converter to generate a first low voltage waveform pulse. The method also includes, with the digital-to-analog converter, generating the first low voltage waveform pulse and transmitting the first low voltage waveform pulse to at least one power amplifier. The method further includes, with the at least one power amplifier, increasing an amplitude of the first low voltage waveform pulse to generate a first high voltage waveform pulse and transmitting the first high voltage waveform pulse to an ultrasound transducer.

In an embodiment, a computer program product for an ultrasound system is disclosed. The computer program product comprises a computer readable storage medium having program code embodied therewith. The program code comprises programming instructions for, with a controller, instructing a digital-to-analog converter to generate a first low voltage waveform pulse. The program code also comprises programming instructions for, with the digital-to-analog converter, generating the first low voltage waveform pulse and transmitting the first low voltage waveform pulse to at least one power amplifier. The program code further comprises programming instructions for, with the at least one power amplifier, increasing an amplitude of the first low voltage waveform pulse to generate a first high voltage waveform pulse and transmitting the first high voltage waveform pulse to an ultrasound transducer. The first high voltage waveform pulse exhibits an amplitude that is greater than the first low voltage waveform pulse.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is a schematic view of an ultrasound system, according to an embodiment.

FIG. 1B is a cross-sectional view of a portion of the ultrasound system taken from circle 1B.

FIG. 2 is a schematic illustration of a pulse generator, according to an embodiment.

FIG. 3 illustrates time domain and frequency domain (i.e., Fourier transforms of the time domain) of various types of pulses that the low voltage waveform pules output from the DAC may exhibit, according to various embodiments.

FIGS. 4A and 4B are graphs illustrating how generating a variety of waveform pulses with the pulse generator facilitates operation of the ultrasound system, according to an embodiment.

FIG. 5 is a block diagram of a method for using any of the pulse generators disclosed herein, according to an embodiment.

### DETAILED DESCRIPTION

Embodiments disclosed herein related to ultrasound systems configured to generate different ultrasound waves and methods of using the same. An example ultrasound system includes a controller. The ultrasound system also includes a digital-to-analog converter (“DAC”) that is in communication with the controller. The DAC is configured to generate a first low voltage waveform pulse (“WP”) responsive to receiving instructions from the controller. The ultrasound system also includes at least one power amplifier in communication with the DAC. The DAC is configured to send the first low voltage WP to the power amplifier and the power amplifier is configured to generate a first high voltage WP responsive to receiving the first low voltage WP. The power amplifier is configured to transmit the first high voltage WP to an ultrasound transducer. The ultrasound transducer may generate a first ultrasound wave responsive to receiving the first high voltage WP.

In an embodiment, the controller is configured to instruct the DAC to generate a second low voltage WP after generating the first low voltage WP. The second low voltage WP may exhibit a waveform that is different than the first low voltage WP. The DAC is configured to generate the second low voltage WP responsive to receiving the instructions from the controller. The DAC is configured to transmit the second low voltage WP to the power amplifier and the power amplifier may generate a second high voltage WP from the second low voltage WP. The power amplifier may transmit the second high voltage WP to the ultrasound transducer. The ultrasound transducer may generate a second ultrasound wave responsive to receiving the second high voltage WP, wherein the second ultrasound wave is different than the first ultrasound wave.

At least some conventional ultrasound systems are configured to generate a single type of high voltage WP. For example, at least some conventional ultrasound systems are configured to generate high voltage WP exhibiting a square pulse pattern. The single type of high voltage WP generated by the conventional ultrasound systems limit the types of ultrasound waves that may be generated by the conventional ultrasound system. Limiting the types of ultrasound waves that the conventional ultrasound systems can generate creates several issues. For example, the limited types of ultrasound waves may only allow the conventional ultrasound to effectively image or otherwise examine (e.g., detect or measure other characteristics of) certain types of material (e.g., stents or tissue such as plaque or vessel walls) within a set range of distances from the ultrasound transducer with certain limited resolution. This means imaging or otherwise examining at least one of other types of material, material outside of the set range of distances, or with certain resolutions, requires using a different ultrasound system assuming the different ultrasound system is even available in the location or even manufactured.

The ultrasound systems disclosed herein are an improvement over conventional ultrasound systems since the ultrasound systems disclosed herein resolve at least some of these issues associated with conventional ultrasound systems. For example, the ultrasound systems disclosed herein are configured to generate various types of WPs, exhibiting different waveforms, such as the first high voltage WP and the second high voltage WP. These different WPs allow the ultrasound system to generate different types of ultrasound waves. For instance, the ultrasound system may generate a first ultrasound wave when the ultrasound system generates the first high voltage WP. The first ultrasound wave may efficiently detect and image or otherwise examine the first types of material within a first range of distances from the ultrasound transducer with first resolution. During use and operation of the ultrasound system, it may be desirable to image or otherwise examine at least one of a second type of material that is different than the first type of material, material that is located a second range of distances away from the ultrasound transducer that is different than the first range of distances, or with a second resolution that is different than the first resolution. As such, after generating the first ultrasound wave, the ultrasound system may generate the second ultrasound wave responsive to receiving the second high voltage WP. The second ultrasound wave may be configured to efficiently image or otherwise examine at least one of the second type of material, material within the second range of distances, or at the second resolution.

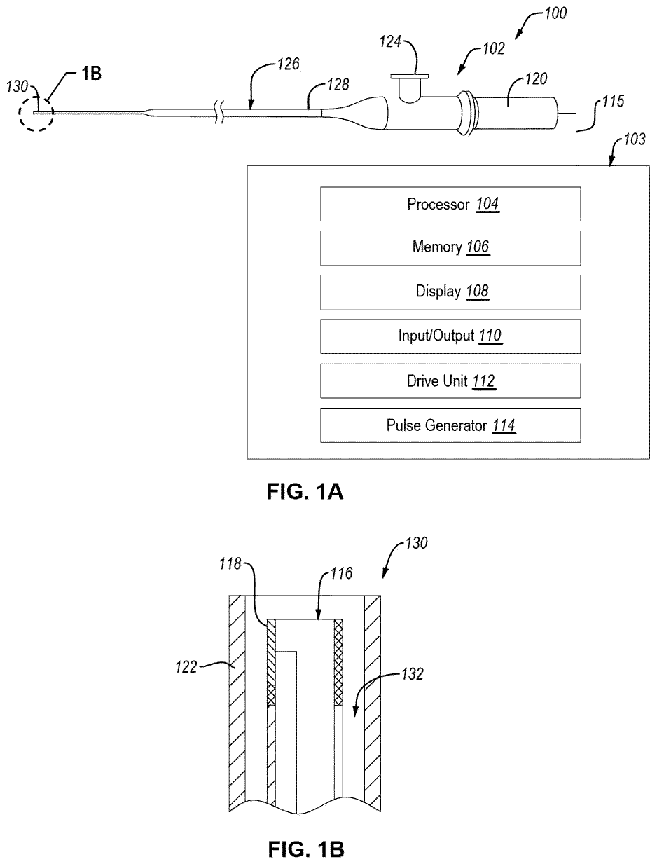

FIG. 1A is a schematic view of an ultrasound system 100, according to an embodiment. FIG. 1B is a cross-sectional view of a portion of the ultrasound system 100 taken from circle 1B. The ultrasound system 100 is an example of an intravenous ultrasound system. That said, the ultrasound system 100 may be used in other types of ultrasound systems. The ultrasound system 100 includes a catheter 102 and a control unit 103. The control unit 103 may include at least one processor 104, memory storage medium 106, one or more displays 108, at least one input/output device 110, a drive unit 112, and a pulse generator 114. It is also noted that the ultrasound system 100 may include any other components found in conventional ultrasound systems.

In an example, as illustrated in FIG. 1A, the ultrasound system 100 is illustrated as including a single control unit 103. The single control unit 103 includes the processor 104, the memory storage medium 106, the displays 108, the input/output device 110, the drive unit 112, and the pulse generator 114. The single control unit 103 is illustrated as being separate and spaced from the catheter 102 but communicably and electrically coupled to the catheter 102 using one or more wires 115. However, it is noted that the control unit 103 may exhibit other configurations. In an example, the control unit 103 may include a plurality of control units communicably coupled together, and each of the plurality of control units include at least one of the processor 104, the memory storage medium 106, the displays 108, the input/output device 110 (e.g., mouse, keyboard, touchscreen, USB drive, etc.), the drive unit 112, or the pulse generator 114. In an example, at least a portion of the control unit 103 (e.g., one of the plurality of control units) may be disposed or directly attached to a hub 120 (e.g., handle) of the catheter 102 or otherwise disposed in or directly attached to the catheter 102.

The processor 104, in conjunction with the memory storage medium 106, is configured to control one or more components of the ultrasound system 100. For example, the memory storage medium 106 may include one or more operational instructions stored thereon. The memory storage medium 106 may include non-transitory memory. For example, the memory storage medium 106 may include RAM, ROM, flash memory, CD-ROM, digital versatile disks (DVD) or other optical storage, solid state drive, hard disk drives, other types of volatile or non-volatile memory, other types of non-transitory memory, or any other suitable device that may store the operation instructions. The processor 104 may execute the operational instructions and, responsive to said execution, may control one or more components of the ultrasound system 100. The processor 104 may direct the drive unit 112 to move one or more portions of the catheter 102 (as will be discussed in more detail below) and/or as conventionally performed, and direct the pulse generator 114 to generate one or more high voltage WP and transmit the high voltage WP to the ultrasound transducer 118 (shown in FIG. 1B). The processor 104 may execute the operational instruction responsive to a user of the ultrasound system 100, via the input/output device 110, instructing the processor 104 to execute the operational instructions or uploading the operational instructions.

The processor 104 and the memory storage medium 106 may also be configured to analyze data generated by the ultrasound system 100 and to provide at least some of the data to the user of the ultrasound system 100. For example, during the use, the ultrasound transducer 118 may detect one or more characteristics of one or more materials and may transmit the characteristics to the processor 104. The processor 104, using programs stored on the memory storage medium 106, may analyze the characteristics sensed by the ultrasound transducer 118 to generate an image of the materials detected by the ultrasound transducer 118. The processor 104 may cause the display 108 to display the image generated by the processor 104. The processor 104 may also analyze the characteristics sensed by the ultrasound transducer 118 to, for instance, at least one of form a preliminary disease diagnosis, calculate plaque burden percentage, determine a location of a lesion, determine lesion morphology, determine calcium volume, detect a thrombus, or calculate luminal cross-sectional measurements. The processor 104 may also cause the analysis to be provided on the display 108.

The drive unit 112 is configured to generate mechanical energy and to transfer the mechanical energy to the catheter 102, thereby allowing one or more components of the catheter 102 to move. In an example, the drive unit 112 may be configured to rotate the imaging core 116 including at least one ultrasound transducer 118. Further, the drive unit 112 may control the velocity of the rotation of the imaging core 116. In an example, the drive unit 112 may be configured to move the imaging core 116 proximally (e.g., towards the hub 120) or distally (e.g., away from the hub 120) relative to a sheath 122 of the catheter 102. In an example, the drive unit 112 is configured to move another component of the catheter 102.

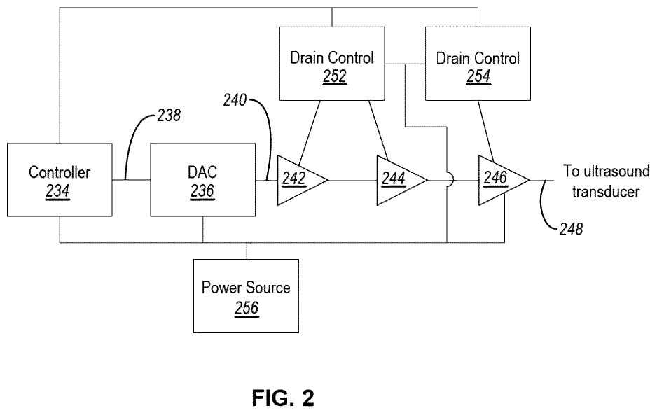

The pulse generator 114 is configured to generate electrical energy and to provide the electrical energy to the ultrasound transducer 118, thereby allowing the ultrasound transducer 118 to generate ultrasound waves. For example, the pulse generator 114 is configured to at least generate a plurality of different WPs (e.g., high voltage WPs) and to transmit the plurality of different WPs to the ultrasound transducer 118. The plurality of different WPs received by the ultrasound transducer 118 may allow the ultrasound transducer 118 to generate and emit different ultrasound waves. The structure and function of the pulse generator 114 and how the pulse generator 114 causes the ultrasound transducer 118 to generate different ultrasound waves will be discussed in more detail below with regards to FIGS. 2-4B.

As previously discussed, the catheter 102 includes a hub 120. The hub 120 is configured to be coupled to the control unit 103. For example, the hub 120 is configured to receive mechanical energy from the drive unit 112, WPs from the pulse generator 114, and transmit information corresponding to reflected ultrasound waves detected by the ultrasound transducer 118 to the processor 104. The hub 120 may also define one or more port 124, such as a flush port or a working port that is configured to receive one or more instruments (e.g., guidewire, surgical tools, etc.). The hub 120 may include one or more additional components found in conventional IVUS hubs.

The catheter 102 also includes an elongated member 126 extending distally away from the hub 120. The elongated member 126 may include a proximal end 128 attached to or disposed in the hub 120 and a distal end 130 longitudinally spaced from the hub 120. The elongated member 126 is configured to be percutaneously inserted into a patient. The elongated member 126 may form a unitary body with the hub 120 or may be separate from and configured to be assembled with the hub 120.

Referring now to FIG. 1B, which is a cross-sectional view of the distal end 130 of the elongated member 126, the elongated member 126 includes the sheath 122. The sheath 122 may extend generally parallel to a longitudinal axis of the elongated member 126. The sheath 122 defines an inner lumen 132. The sheath 122 may be formed from a material that is substantially transparent to ultrasound waves or otherwise has minimal effect on the ultrasound waves transmitted and received by the ultrasound transducer 118.

The imaging core 116 is at least partially positioned within the inner lumen 132. The imaging core 116 includes at least one ultrasound transducer 118. At least the ultrasound transducer 118 (e.g., array of ultrasound transducers) of the imaging core 116 is configured to move (e.g., rotate) relative to the sheath 122. Rotating the ultrasound transducer 118 relative to the sheath 122 allows the ultrasound transducer 118 to emit the ultrasound waves at a variety of radial directions and detect the reflected ultrasound waves from the variety of radial directions. This, in turn, allows the ultrasound transducer 118 to form an image of the area radially surrounding the ultrasound transducer 118.

Examples of the materials and structures of the ultrasound transducer 118 are disclosed in U.S. Pat. No. 11,064,972 issued on Jul. 20, 2021, the disclosure of which is incorporated herein, in its entirety, by this reference. For example, the ultrasound transducer 118 may include 1 to 1,000 ultrasound transducers. The ultrasound transducer 118 may also include one or more piezoelectric ceramic materials, one or more piezocomposite materials, one or more piezoelectric plastics, barium titanate, lead zirconate titanate, lead metaniobate, polyvinylidene fluoride, other composite materials, single-crystal composites, capacitive micromachined ultrasound transducers, piezoelectric micromachined ultrasound transducers, other semiconductor devices, other ultrasound transducers, or combinations of the foregoing. It is noted that the ultrasound transducer 118 may include any conventional materials and structures.

During use, the ultrasound transducer 118 may emit one or more ultrasound waves responsive to receiving the high voltage WPs from the pulse generator 114. In particular, the ultrasound transducer 118 may form pressure distortions on the surface thereof to form the ultrasound waves based on the resonant frequency of the ultrasound transducer. The ultrasound waves may exhibit sufficient energy that a portion of the ultrasound wave is reflected back to the ultrasound transducer 118, such as when the ultrasound wave interacts with one or more medium boundaries. The ultrasound transducer 118 may detect the reflected ultrasound waves and generate electrical signals responsive to detecting the reflected ultrasound waves. This electrical signal may be transmitted back to the control unit 103 for further analysis to generate an image.

FIG. 2 is a schematic illustration of a pulse generator 214, according to an embodiment. The pulse generator 214 may be used in any of the ultrasound systems disclosed herein or in any conventional ultrasound system, without limitation. The pulse generator 214 is configured to generate a plurality of different high voltage WPs that can be transmitted to the ultrasound transducer (e.g., the ultrasound transducer 118 of FIG. 1B).

The pulse generator 214 includes a controller 234 (e.g., field programmable gate array) and a digital-to-analog converter (“DAC”) 236. The controller 234 is communicably coupled to the DAC 236. The controller 234 is configured to output one or more control instructions 238 to the DAC 236. The control instructions 238 instruct the DAC 236 to generate one or more low voltage WP 240. For example, the control instructions 238 may include instructions to generate a low voltage WP exhibiting at least one of a certain type of waveform (e.g., square pulse, gaussian pulse, etc.), a certain frequency or range of frequencies, a certain amplitude or range of amplitudes, or any other type of WP.

The controller 234 may include a processor and memory storage medium. The memory storage medium may include operational instructions stored thereon. The controller 234 may generate the control instructions 238 responsive to executing the operational instructions stored on the memory storage medium. In an example, the controller 234 may receive input from a user of the ultrasound system that includes the pulse generate 214. The controller 234 may receive the input, for instance, responsive to the user input information into the ultrasound system using an input/output device. The input may include, from the user, instructions adjusting certain settings (e.g., contrast or brightness settings), instructions to use a certain WP to generate the ultrasound waves, instructions to detect material a certain distance from the ultrasound transducer, instructions to detect certain types of material, etc. The input may cause the processor of the controller 234 to execute one or more of the operational instructions stored on the memory storage medium which, in turn, causes the controller 234 to instruct the DAC 236 to generate a certain low voltage WP. In an example, the controller 234 may receive input from the control unit (e.g., the control unit 103 of FIG. 1A). For instance, the control unit may generate an image from the signals received from the ultrasound transducer. The control unit may determine that the ultrasound waves used to generate the image need to be adjusted, for example, to improve image quality or efficiency. Assuming the processor of the control unit is distinct from the processor of the controller 234, the processor of the control unit may then send input to the controller 234 to adjust the ultrasound waves generated by the ultrasound transducer. Such input may cause the processor of the controller 234 to execute one or more of the operational instructions stored on the memory storage medium which, in turn, causes the controller 234 to instruct the DAC 236 to generate a certain low voltage WP.

In an embodiment, the controller 234 of the pulse generator 214 is distinct from the processor and memory storage device of the control unit. In such an embodiment, the control unit that includes the pulse generator 214 may include at least two processors and memory storage devices (e.g., one for the control unit itself and one for the pulse generator 214). In an embodiment, the processor and memory storage of the control unit also form the controller 234 of the pulse generator 214.

As previously discussed, the DAC 236 is configured to generate low voltage WPs 240, exhibiting a plurality of different types of waveforms. These low voltage WPs 240 allow the pulse generator 214 to generate high voltage WPs 248 and provide the high voltage WPs 248 to the ultrasound transducer. The variety high voltage WPs 248 provided to the ultrasound transducer allows the ultrasound transducer to emit different ultrasound waves that may improve the image quality and the efficiency of the ultrasound system compared to conventional ultrasound systems. For example, conventional ultrasound systems can output a high voltage WP, exhibiting a single waveform to the ultrasound system which, in turn, limits the ultrasound waves that can be omitted by the ultrasound transducer of the conventional ultrasound systems. The limited ultrasound waves emitted by the ultrasound transducer of the conventional ultrasound systems limits the image quality and the efficiency of the conventional ultrasound systems. However, at least because of the DAC 236 of the pulse generator 214 and the particular configurations of the pulse generator 214, the ultrasound system including the pulse generator 214 is not so limited, as will be discussed in more detail below.

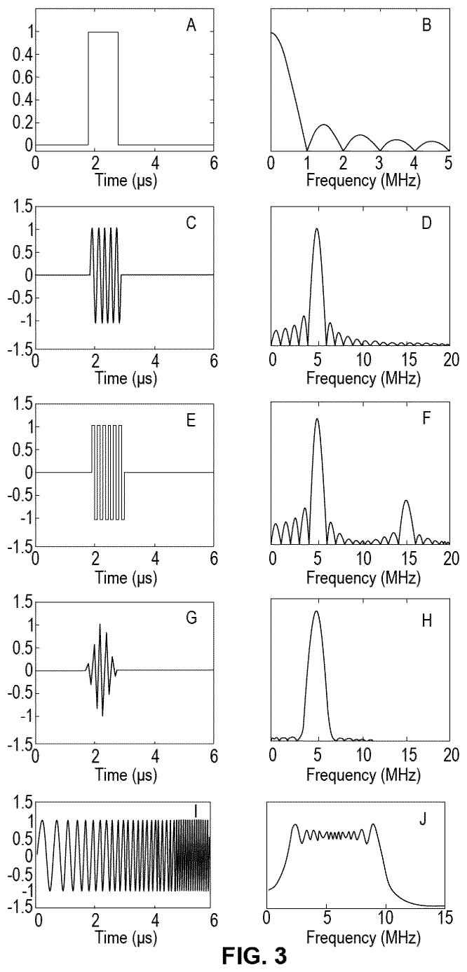

FIG. 3 illustrate the time domain and frequency domain (i.e., Fourier transforms of the time domain) of various types of pulses that the low voltage WPs 240 output from the DAC 236 may exhibit. In particular, graphs A and B of FIG. 3 are the time domain and frequency domain, respectively, of a square WP; graphs C and D of FIG. 3 are the time domain and frequency domain, respectively, of a tone burst WP; graphs E and F of FIG. 3 are the time domain and frequency domain, respectively, of a square blast WP; graphs G and H of FIG. 3 are the time domain and frequency domain, respectively, of a Gaussian WP; and graphs I and J of FIG. 3 are the time domain and frequency domain, respectively, of a chirp WP. It is noted that the DAC 236 may be configured to output low voltage WPs 240 exhibiting only some of the WPs illustrated in graphs A-J of FIG. 3 and/or may be configured to output low voltage WPs, exhibiting pulses that are not illustrated in graphs A-J of FIG. 3 (e.g., cosine squared WP, Dirac WP, Nyquist WP, etc.).

Referring back to FIG. 2, the DAC 236 is in electrical communication with one or more power amplifiers, such as a first power amplifier 242, a second power amplifier 244, and the final power amplifier 246. This electrical communication between the DAC 236 and the power amplifiers allows the DAC 236 to output the low voltage WP 240 to the power amplifier 244. The power amplifiers may increase the voltage of the low voltage WP 240 received thereby such that the power amplifiers output the high voltage WP 248 to the ultrasound transducer. It is noted that the high voltage WP 248 may be substantially the same as the low voltage WP 240 (e.g., exhibit the same frequency, waveform, etc.) except that the voltage of the high voltage WP 248 is greater than the low voltage WP 240.

The pulse generator 214 may include any number of power amplifiers. Generally, the pulse generator 214 includes two or more power amplifiers since one power amplifier typically is unable to generate a high voltage WP 248, exhibiting a sufficiently high voltage and quality for use in most ultrasound applications. For example, a single amplifier may not have a gain-bandwidth product that is sufficient to convert the low voltage WP 240 to the high voltage WP 248 having a sufficiently high voltage. As such, generally, the pulse generator 214 may include two or more power amplifiers, such as three power amplifiers (as shown), four power amplifiers, five power amplifiers, or six or more power amplifiers. The number of power amplifiers in the pulse generator 214 may be selected for a variety of reasons. In an example, the number of power amplifiers may depend on the voltage of the low voltage WP 240 outputted from the DAC 236, the desired increase in voltage of the low voltage WP, the distance from the ultrasound transducer to the material that is to be imaged or otherwise examined, and the waveform of the WP (e.g., as will be discussed below, some WPs generate ultrasound waves with high intensity peaks and such WPs will require lower voltage gains than other WPs). In an embodiment, the pulse generator 214 is configured to adjust the voltage gain between the low voltage WP 240 and the high voltage WP 248.

The pulse generator 214 also includes at least one drain control electrically coupled to the power amplifiers, such as a first drain control 252 and a second drainage control 254. The drain control of the pulse generator 214 may also be communicably coupled to the controller 234 such that the controller 234 may at least partially control the operation of the drain control. The drain control is configured to facilitate complete shut down of the power amplifiers of the pulse generator 214. For example, the power amplifiers may output a “tail” of electrical power when the power amplifiers are shut down. The tail of electrical power can distort the high voltage WP 248 outputted by the power amplifiers which, in turn, generates significant noise in the ultrasound wave generated by the ultrasound transducer and image generated by the ultrasound wave. The drain control is configured to drain the tail of electrical power as the power amplifiers are shut down to prevent, or at least inhibit the tail of electrical power from distorting the high voltage WP 248. In other words, the drain control improves the quality of the high voltage WP 248 outputted by the power amplifiers which, in turn, improves the quality of the ultrasound wave and the image generated by the ultrasound wave. In an example, the controller 234 may indicate when the power amplifiers are to be shut down, thereby indicating to the drain control when the drain control may drain the tail of electrical power.

In an embodiment, the pulse generator 214 may include a plurality of drain controls. Each of the plurality of drain controls may be electrically coupled to one or more of the power amplifiers. For example, as illustrated, the first drain control 252 may be electrically coupled to the first and second power amplifiers 242, 244 and the second drain control 254 may be electrically coupled to the final power amplifier 246. The plurality of power amplifiers allows for better drainage of the tail of electrical power from each of the power amplifiers than if the pulse generator 216 included a single drain control. For example, the first drain control 252 may facilitate the first and second power amplifiers 242, 244 to output high quality voltage WP outputted to the final power amplifier 248. The high quality voltage WP provided to the final power amplifier 248 may facilitate the final power amplifier 248 generating the high voltage WP 248, exhibiting high quality since the quality of the high voltage WP 248 depends, in part, on the quality of the voltage WP received by the final power amplifier 248. Similarly, the second drain control 254 may facilitate the third power amplifier 246 to output the high voltage WP 248, exhibiting a high quality. In a particular example, when the pulse generator 214 includes a plurality of drain controls, one of the drain controls may only be electrically coupled to the last power amplifier that generates the high voltage WP 248 and outputs the high voltage WP 248 to the ultrasound transducer (e.g., the final power amplifier 246 illustrated in FIG. 2) to directly ensure the quality of the high voltage WP 248.

The pulse generator 214 may include a power source 256. The power source 256 is electrically coupled (either directly or indirectly) to one or more components of the pulse generator 214 and is configured to power the components of the pulse generator 214. For example, the power source 256 may be configured to provide electrical power to the controller 234, the DAC 236, the power amplifiers, and the drain control. The power source 256 may include any suitable power source 256, such as a battery or a plug that is configured to be connected to an electrical outlet.

In an embodiment, unlike at least some conventional ultrasound systems, the pulse generator 214 does not include a metal-oxide-semiconductor field effect transistor (“MOSFET”) driver or array since the pulse generator 214 may be unable to generate a plurality of different high voltage WPs if the pulse generator 214 included such devices.

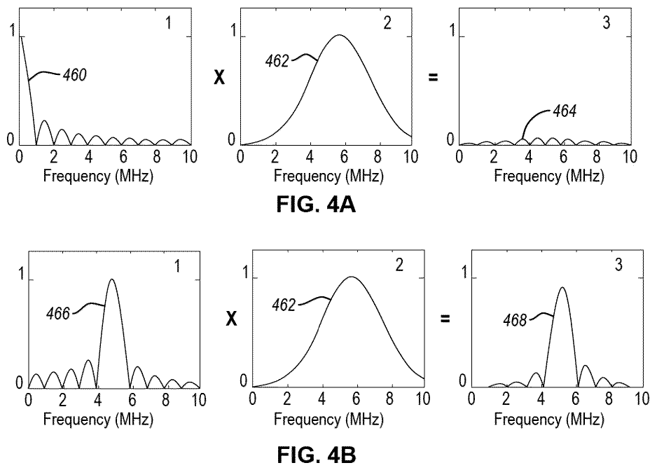

As previously discussed, the pulse generator 214 is configured to generate a variety of WPs. Graphs A-J of FIG. 3 illustrates several different WPs (as a function of time and frequency) of several different types of WPs. FIGS. 4A and 4B are graphs illustrating how generating a variety of WPs with the pulse generator facilitates operation of the ultrasound system, according to an embodiment. Referring to FIG. 4A, in graph 1, the square WP 460 is shown as a function of frequency, as shown in graph B of FIG. 3. In graph 2 of FIG. 4A, an example frequency response characteristic curve of the transducer 462 (e.g., the output ultrasound wave power divided by the input electrical power in different frequencies), as a function of frequency, is shown. It is noted that the frequency response characteristic curve of the transducer 462 may vary between different ultrasound transducers. The ultrasound wave 464 generated and outputted by the ultrasound transducer using the square WP 460 is shown in graph 3 of FIG. 4A (which is the result of multiplying the square WP 460 and the frequency response characteristic curve of the transducer 462 together) and exhibits a plurality of low intensity peaks.

Referring to FIG. 4B, in graph 1, the tone burst WP 466 is shown as a function of frequency, as shown in graph D of FIG. 3. It is noted that the tone burst WP 466 shown in graph 1 of FIG. 4B exhibits a peak voltage equal to the square WP 460 shown in graph 1 of FIG. 4A. In graph 2 of FIG. 4B, the example frequency response characteristic curve of the transducer 462 is shown. The ultrasound wave 468 generated and outputted by the ultrasound transducer using the tone burst WP 466 is shown in graph 3 of FIG. 4B (which is the result of multiplying the tone burst WP 466 and the frequency response characteristic curve of the transducer 462) and exhibits a single, high intensity peak and several low intensity peaks.

FIGS. 4A and 4B demonstrate that some WPs are able to generate ultrasound waves from the ultrasound transducer more efficiently than other WPs. For example, as shown in graphs 3 of FIGS. 4A and 4B, the tone burst WP 466 can generate a higher intensity ultrasound peak than the square WP 462, even though the tone burst WP 466 and the square WP 462 exhibit the same peak voltage. As such, the pulse generator may generate an ultrasound wave exhibiting a desired peak, while at least one of using fewer power amplifiers, using less electrical power, or outputting high voltage WPs 248 having lower (and safer) voltages if the pulse generator outputs tone burst WPs 466 instead of square WPs 460.

However, the WP outputted by the pulse generator may be selected for reasons other than which WP may most efficiently generate ultrasound waves. In an embodiment, the WP generated by the pulse generator may be generated based on the distance between the ultrasound transducer and the target material (i.e., the stent, plaque, vessel wall, other tissue, or other material to be imaged or otherwise examined). It is currently believed that higher intensity ultrasound waves are better able to image or otherwise examine a target material that is further spaced from the ultrasound transducer. For example, the ultrasound wave 468 may be better able to image or otherwise examine a material that is further from the ultrasound transducer than the ultrasound wave 464. However, higher intensity ultrasound wave may be unable to image or otherwise examine a target material that is close to the ultrasound transducer. As such, the ultrasound wave 464 may be used to image or otherwise examine a target material that is close to the ultrasound transducer. As such, the pulse generator may change the WP outputted therefrom depending on the relative distance between the ultrasound transducer and the target material. For instance, the pulse generator may change the WP outputted therefrom as the target material changes from material that is relatively close to the ultrasound transducer to material that is relatively far from the ultrasound transducer.

In an embodiment, the WP generated by the pulse generator may be generated based on frequencies of one or more peaks of the ultrasound waves generated by the ultrasound transducer. For example, ultrasound waves exhibiting one or more frequencies may be better able to image or otherwise examine a target material than ultrasound waves exhibiting other frequencies. For instance, stents, plaque, and vessels walls may be better imaged or otherwise examined using different frequencies of ultrasound waves. As such, the pulse generator may generate ultrasound waves based on the frequency or frequencies that are better suited to image or otherwise examine the target material. For example, the ultrasound wave 464 generated using the square WP 460 exhibits peaks at a plurality of frequencies. As such, the ultrasound wave 464 may be used to image or otherwise examine a variety of target materials that interact better with these different frequencies. The ultrasound wave 468 generated using the tone burst WP 466 also exhibits peaks at a plurality of frequencies. However, the single, high intensity peak may dominate the other peaks such that only the single, high intensity peak may be used to image or otherwise examine the target material. In other words, the ultrasound wave 464 may be used to image or otherwise examine more or different target materials than the ultrasound wave 468.

In an embodiment, the WP generated by the pulse generator may be selected based on the acceptable amount of noise generated when imaging or otherwise examining the target material. In an example, the ultrasound wave 464 generated using the square WP 460 exhibits several peaks having similar intensity compared to the peaks of the ultrasound wave 468. These different peaks may create a relatively large amount of noise when imaging or otherwise examining the target material. In certain embodiments, the ultrasound wave 464 may not be suitable when high quality imaging or examination of the target material is needed. In an example, the ultrasound wave 468, generated using the tone burst WP 466, also includes a plurality of peaks. However, the single, high intensity peak may dominate the other peaks such that the noise generated by the other peaks of the ultrasound wave 468 generated relatively low quantity of noise. As such, in certain embodiments, the ultrasound wave 468 may be suitable when high quality imaging or examination of the target material is needed.

The square burst WP shown in graphs E and F of FIG. 3 generates an ultrasound wave that is substantially similar to the ultrasound wave 468 generated by the tone burst WP 466, except that the ultrasound wave generated by the square WP includes one or more additional peaks at higher frequencies. For example, the ultrasound wave generated with the square WP includes a first set of peaks exhibiting a single, high intensity peak with a plurality of peaks around the high intensity peak that may be dominated by the high intensity peak. As such, the first set of peaks of the ultrasound wave generated with the square WP may behave similar to the ultrasound wave generated with the tone burst WP 466 and, thus, may exhibit the same benefits as, and be used in many of the same situations as, the ultrasound wave generated by the tone burst WP 466. However, the ultrasound wave generated using the square WP may include a second set of peaks at a higher frequency than the first set of peaks. The second set of peaks may include a high intensity peak and a plurality of other peaks. The presence of the second set of peaks may allow the ultrasound wave generated by the square WP to image or otherwise examine target materials that interact with a high frequency ultrasound wave. The second set of peaks may exhibit frequencies that are sufficiently different than the first set of peaks that the significant noise, generated by the first set of peaks, can be at least partially filtered out. It is noted that the second set of peaks may increase the noise generated by the ultrasound wave compared to the ultrasound wave generated by the tone burst WP 466 but that this noise may be able to be at least partially filtered out. The second set of peaks may also not be as efficient at generating ultrasound waves compared to the first set of peaks.

The Gaussian pulse WP shown in graphs G and H of FIG. 3 generates an ultrasound wave that includes a single, high intensity peak. Any additional peaks generated by the gaussian WP (if any) are negligible. The ultrasound wave generated using the gaussian WP may be the most efficient WP shown in graphs A-J of FIG. 3 at generating ultrasound waves, generating ultrasound wave with little to no noise, and imaging or otherwise examining target material that is relatively spaced from the ultrasound wave transducer. However, the ultrasound wave generated using the gaussian WP may be ineffective at imaging or otherwise examining target material that is relatively close to the ultrasound transducer. Also, since the ultrasound wave generated with the gaussian WP exhibits a single peak, the ultrasound wave generated with the gaussian WP may be ineffective at imaging or otherwise examining a plurality of different target materials that interact better with ultrasound wave exhibiting different frequencies.

The chirp WP shown in graphs I and J of FIG. 3 generates an ultrasound wave exhibiting a peak exhibiting a full width at half maximum (“FWHM”) that is greater than the ultrasound waves generated by the other WPs illustrated in graphs A-H of FIG. 3. The peak exhibiting the large FWHM may include a plurality of local peaks extending therefrom. The large FWHM of the ultrasound wave allows the ultrasound wave to detect a variety of target materials that interact better with different frequencies or at various distances from the ultrasound transducer. However, the large FWHM of the ultrasound wave generated with the chirp WP may cause the ultrasound wave to generate relatively large quantities of noise compared to other WPs. That said, the chirp WP may be relatively effective at generating ultrasound waves.

It is noted that the behavior, benefits, and uses of the WPs discussed above may vary if the frequency response characteristic curve of the transducer of the ultrasound transducer is significantly different than the example frequency response characteristic curve of the transducer 462. In an example, a frequency response characteristic curve of the transducer exhibiting a peak at a frequency similar to the frequencies of the right-most set of peaks of the square pulse shown in graph F of FIG. 3, may cause the second set of peaks of the ultrasound wave generated thereby to exhibit an intensity that is greater than the first set of peaks. In an example, the gaussian WP may not efficiently generate ultrasound waves if the frequency of the peak of the frequency response characteristic curve of the transducer is offset from the peak of the gaussian WP.

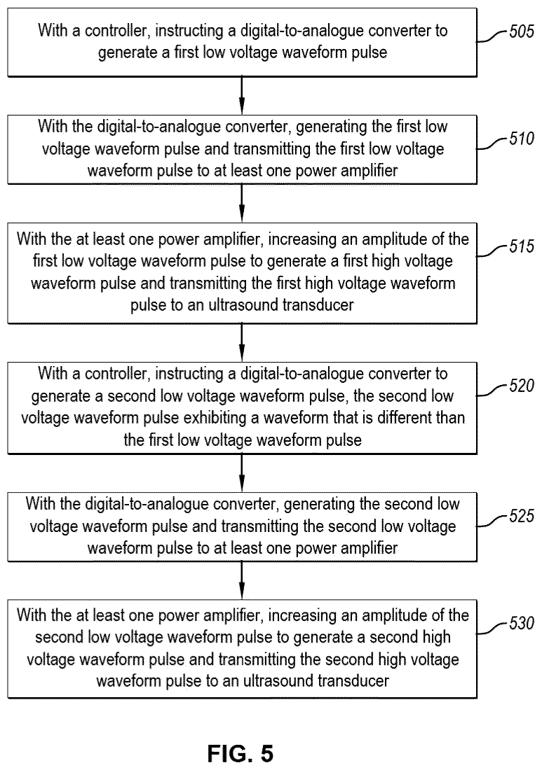

FIG. 5 is a block diagram of a method 500 for using any of the pulse generators disclosed herein, according to an embodiment. The method 500 may include one or more operations, functions, or actions as illustrated in the blocks 505, 510, 515, 520, 525, and 530. One or more of the blocks 505, 510, 515, 520, 525, or 530 may be performed responsive to instructions from at least one processor executing instructions stored on a computer-readable medium. It is noted that the blocks included in the method 500 are for illustrative purposes. One or more of the blocks included in the method 500 may be performed in a different order, omitted, divided into two or more blocks, supplemented, or combined. Further, additional blocks may be added to the method 500, such as blocks resulting in the ultrasound transducer emitting a third ultrasound wave that is different than the first and second ultrasound waves.

Blocks 505-515 result in an ultrasound transducer emitting a first ultrasound wave. For example, block 505 recites, “with a controller, instructing a digital-to-analog converter to generate a first low voltage waveform pulse” and block 510 recites, “with the digital-to-analog converter, generating the first low voltage waveform pulse and transmitting the first low voltage waveform pulse to at least one power amplifier.” The first low voltage WP generated responsive to blocks 505 and 510 may include any of the WPs disclosed herein or any other suitable WP. For example, first low voltage WP generated responsive to blocks 505 and 510 may include a square WP, a tone burst WP, a square burst WP, a gaussian WP, a chirp WP, a cosine squared WP, a dirac WP, a sinc WP, or any other suitable WP.

Block 515 recites, “with the at least one power amplifier, increasing an amplitude of the first low voltage waveform pulse to generate a first high voltage waveform pulse and transmitting the first high voltage waveform pulse to an ultrasound transducer.” For example, block 515 includes increasing the voltage of the first low voltage WP until the WP exhibits a sufficiently high voltage to be the first high voltage WP. The first high voltage WP exhibits the same waveform as the first low voltage WP. It is noted that the first high voltage WP outputted in block 515 causes the ultrasound transducer to generate a first ultrasound wave.

Blocks 520-530 result in the ultrasound transducer emitting a second ultrasound wave that is different than the first ultrasound wave. For example, blocks 520-530 may result in the second ultrasound wave exhibiting a peak intensity, one or more peaks, peaks exhibiting different frequencies, etc., than the first ultrasound wave. Block 505 recites, “with a controller, instructing a digital-to-analog converter to generate a second low voltage waveform pulse, the second low voltage waveform pulse exhibiting a waveform that is different than the first low voltage waveform pulse” and block 525 recites, “with the digital-to-analog converter, generating the second low voltage waveform pulse and transmitting the second low voltage waveform pulse to at least one power amplifier.” The second low voltage WP generated responsive to blocks 520 and 525 may include any of the WPs disclosed herein or any other suitable WP so long as the WP is different than the WP of the first low voltage WP.

Block 530 recites, “with the at least one power amplifier, increasing an amplitude of the second low voltage waveform pulse to generate a second high voltage waveform pulse and transmitting the second high voltage waveform pulse to an ultrasound transducer.” For example, block 530 includes increasing the voltage of the second low voltage WP until the WP exhibits a sufficiently high voltage to be the second high voltage WP. The second high voltage WP exhibits the same waveform as the second low voltage WP and, thus, the WP of the second high voltage WP is different than the WP of the first high voltage WP. It is noted that the second high voltage WP outputted in block 530 causes the ultrasound transducer to generate the second ultrasound wave.

It is noted that the method 500 may include outputting a third high voltage WP to the ultrasound transducer that is different than the first and second high voltage WPs to generate a third ultrasound wave that is different than the first and second ultrasound waves, to output a fourth high voltage WP that is different than the first, second, and third high voltage WPs to generate a fourth ultrasound wave that is different than the first, second, and third ultrasound waves, and so forth, using blocks that are substantially similar to one or more of blocks 505-530. Further, the method 500 may include repeating one or more of the blocks 505-530. For example, after already performing each of blocks 505-530 in the sequence listed, the method 500 may include repeating blocks 505-515 to generate the first ultrasound wave.

The method 500 may switch from generating the first ultrasound wave (e.g., performing blocks 505-515) to the second ultrasound wave (e.g., performing blocks 520-530) for several reasons. In an embodiment, the method 500 may generate the first ultrasound wave because the first ultrasound wave is satisfactory at imaging or otherwise examining a first target material. However, after imaging or otherwise examining the first target material, it may be desirable to image or otherwise examine a second target material that is different than the first target material. The first ultrasound wave used to image or otherwise examine the first target material may not be able to satisfactory image or otherwise examine the second target material, for example, because the second target material is spaced from the ultrasound transducer by a distance that is different than the distance between the ultrasound transducer and the first target material or the second target material may interact with ultrasound waves exhibiting a different frequency or frequencies than the first ultrasound wave. With conventional ultrasound methods, the second target material may need to be imaged or otherwise examined by the same ultrasound waves that imaged or otherwise examined the first target material resulting in less-than-optimal imaging or examination of one or more of the first target material or the second target material. However, the method 500 allows different high voltage WPs to be outputted to the ultrasound transducer such that the ultrasound wave(s) that are more effective at imaging or otherwise examining the first and second target materials are used instead of using inferior ultrasound waves.

In an embodiment, the method 500 may generate the first ultrasound wave to image or otherwise examine the first target material. However, it may be determined that the first ultrasound wave is unable to satisfactorily image or otherwise examine the first target material. The first ultrasound wave may unsatisfactorily image or otherwise examine the first target material for a variety of reasons, such as the first ultrasound wave generates too much noise, the first target material is too close or far away from the ultrasound transducer to effectively image or otherwise examine the first target material, it is determined that high quality imaging or otherwise examining of the first target material is needed, the first ultrasound wave is unable (for any number of reasons) of imaging or otherwise examining one or more features of the first target material, or a user of the ultrasound system believes that another type of ultrasound wave would be more effective. Again, with conventional ultrasound methods, the first target material may only be imaged or otherwise examined by the first ultrasound wave even though the first ultrasound wave is not satisfactorily effective. However, the method 500 allows other ultrasound(s) to be used to image or otherwise examine the first target material, including cycling through a plurality of ultrasound waves until the most effective ultrasound wave is found.

The method 500 may switch from generating the first ultrasound wave (e.g., performing blocks 505-515) to the second ultrasound wave (e.g., performing blocks 520-530) responsive to receiving an input. In an embodiment, the input that causes the method 500 to switch from generating the first ultrasound wave to the second ultrasound wave may be made responsive to a user (e.g., medical practitioner, such as a doctor or ultrasound technician) input instructions into the ultrasound system (e.g., via the input/output device 110). In such an embodiment, the user may desire better imaging or otherwise examining of one or more target materials and may input instructions to the system in an attempt to improve imaging or otherwise examining of the one or more target materials. In an embodiment, the ultrasound system (e.g., the processor 104 or the controller 234) itself may determine that the method 500 switches from generating the first ultrasound wave to the second ultrasound wave. For example, the ultrasound system may determine that the first ultrasound wave is generating too much noise, or the ultrasound system is switching from imaging or otherwise examining the first target material to the second target material. In such an example, the ultrasound system itself may switch from generating the first ultrasound wave to the second ultrasound wave to decrease the noise or to more effectively image or otherwise examine the second target material.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. An ultrasound system, comprising:
a controller;
a digital-to-analog converter in communication with the controller, the digital-to-analog converter configured to generate a first low voltage waveform pulse responsive to receiving one or more instructions from the controller;
at least one power amplifier in electrical communication with the digital-to-analog converter, the at least one power amplifier configured to generate a first high voltage waveform pulse after receiving the first low voltage waveform pulse, the first high voltage waveform pulse exhibiting an amplitude that is greater than the first low voltage waveform pulse;
wherein the at least one power amplifier is configured to transmit the first high voltage waveform pulse to an ultrasound transducer.

2. The ultrasound system of claim 1, wherein the first low voltage waveform pulse includes a square waveform pulse.

3. The ultrasound system of claim 1, wherein the first low voltage waveform pulse includes at least one of a tone burst waveform pulse or a square burst waveform pulse.

4. The ultrasound system of claim 1, wherein the first low voltage waveform pulse includes at least one of a Gaussian burst waveform pulse or a chirp waveform pulse.

5. The ultrasound system of claim 1, wherein:
the digital-to-analog converter is configured to generate a second low voltage waveform pulse responsive to receiving one or more additional instructions from the controller, the second low voltage waveform pulse exhibiting a waveform that is different than the first low voltage waveform pulse; and
the at least one power amplifier is configured to generate a second high voltage waveform pulse after receiving the second low voltage waveform pulse, the second high voltage waveform pulse exhibiting a waveform that is different than the first high voltage waveform pulse, the second high voltage waveform pulse exhibiting an amplitude that is greater than the second low voltage waveform pulse.

6. The ultrasound system of claim 1, wherein the at least one power amplifier includes a plurality of power amplifiers.

7. The ultrasound system of claim 1, further comprising a power source in electrical communication with the digital-to-analog converter.

8. The ultrasound system of claim 1, further comprising at least one drain control in electrical communication with the at least one power amplifier, the at least one drain control configured to facilitate shut down of the at least one power amplifier.

9. The ultrasound system of claim 1, further comprising the ultrasound transducer in electrical communication with the at least one power amplifier.

10. The ultrasound system of claim 1, wherein the ultrasound system does not include a MOSFET driver or MOSFET array.

11. A method of using an ultrasound system, the method comprising:
with a controller, instructing a digital-to-analog converter to generate a first low voltage waveform pulse;
with the digital-to-analog converter, generating the first low voltage waveform pulse and transmitting the first low voltage waveform pulse to at least one power amplifier; and
with the at least one power amplifier, increasing an amplitude of the first low voltage waveform pulse to generate a first high voltage waveform pulse and transmitting the first high voltage waveform pulse to an ultrasound transducer.

12. The method of claim 11, wherein the first low voltage waveform pulse includes a square waveform pulse.

13. The method of claim 11, wherein the first low voltage waveform pulse includes at least one of a tone burst waveform pulse or a square burst waveform pulse.

14. The method of claim 11, wherein the first low voltage waveform pulse includes at least one of a gaussian burst waveform pulse or a chirp waveform pulse.

15. The method of claim 11, wherein the at least one power amplifier includes a plurality of power amplifiers.

16. The method of claim 11, further comprising, after instructing the digital-to-analog converter to generate the first low voltage waveform pulse:
with a controller, instructing the digital-to-analog converter to generate a second low voltage waveform pulse, the second low voltage waveform pulse exhibiting a waveform that is different than the first low voltage waveform pulse;
with the digital-to-analog converter, generating the second low voltage waveform pulse and transmitting the second low voltage waveform pulse to the at least one power amplifier; and
with the at least one power amplifier, increasing an amplitude of the second low voltage waveform pulse to generate a second high voltage waveform pulse and transmitting the second high voltage waveform pulse to the ultrasound transducer, the second high voltage waveform pulse exhibiting a waveform that is different than the first high voltage waveform pulse.

17. The method of claim 16, wherein the second high voltage waveform pulse is selected to view a second target material that is spaced a different distance from the ultrasound transducer than a first target material.

18. The method of claim 17, wherein the first high voltage waveform pulse is a square waveform pulse, and the second high voltage waveform pulse is one of a tone burst waveform pulse, a square burst waveform pulse, a gaussian waveform pulse, or a chirp waveform pulse.

19. The method of claim 16, wherein first high voltage waveform pulse is selected to view a first target material and the second high voltage waveform pulse is selected to view a second target that is different than the first target material.

20. A computer program product for an ultrasound system, the computer program product comprising a computer readable storage medium having program code embodied therewith, the program code comprising programming instructions for:
with a controller, instructing a digital-to-analog converter to generate a first low voltage waveform pulse;
with the digital-to-analog converter, generating the first low voltage waveform pulse and transmitting the first low voltage waveform pulse to at least one power amplifier; and
with the at least one power amplifier, increasing an amplitude of the first low voltage waveform pulse to generate a first high voltage waveform pulse and transmitting the first high voltage waveform pulse to an ultrasound transducer, the first high voltage waveform pulse exhibiting an amplitude that is greater than the first low voltage waveform pulse.
